(19) United States
(12) Patent Application Publication
(10) Pub. No.: US 2013/0032033 A1
(43) Pub. Date: Feb. 7, 2013

(54) System and Method for Analysing Exhaust Gas

(71) Applicants: Wayne Anthony Bint, Eynsham (GB); Daniel Kenneth Skelton, Godstone (GB); Timothy John Rogers, Biggin Hill (GB)

(72) Inventors: Wayne Anthony Bint, Eynsham (GB); Daniel Kenneth Skelton, Godstone (GB); Timothy John Rogers, Biggin Hill (GB)

(73) Assignee: Seratel Limited, Godstone, Surrey (GB)

(21) Appl. No.: 13/508,339

(22) PCT Filed: Nov. 8, 2010
(86) PCT No.: PCT/GB2010/002050

§ 371 Date: Sep. 18, 2012

(30) Foreign Application Priority Data
Nov. 6, 2009 (GB) 0919531.4

(51) Int. Cl. B01D 39/20; B01D 46/42

(52) U.S. Cl. 96/417

(57) ABSTRACT

A system for analysing exhaust gas, comprising: a sensor for sensing a properly of exhaust gas: a conduit for transferring exhaust gas from part of an exhaust system to the sensor; and an inorganic filter element configured to remove particulates from exhaust gas between an end of the conduit and the sensor. A method of analysing exhaust gas is also disclosed.

The present invention relates to systems and methods for analysing exhaust gas.

There are many sources of exhaust gases from the combustion of fuel, such as motor vehicles, furnaces, boilers, heal generators, electricity generators, power plants, etc. These exhaust gases contain many different pollutants. These pollutants include hydrocarbons (HC), carbon monoxide (CO), nitrogen oxides (NOₓ), carbon dioxide (CO₂), sulphur oxides (SOₓ) and particulates. Some of these pollutants have been demonstrated to have significant effects on human, animal, plant, and environmental health and welfare. Thus many government agencies around the world have been charged with regulating exhaust emissions. The exhaust emissions from vehicles are regularly tested and analysed to ensure the vehicles meet emissions standards. The emissions from other sources (such as those mentioned above) also need to be controlled.

Gas analysers, which are systems for analysing exhaust gas are commonly used to measure the gaseous emissions from internal combustion engines. The gas analysers can also be used to provide additional information on the condition of an internal combustion engine. For example, CO₂, NOₓ and oxygen (O₂) readings can indicate the efficiency of combustion in the combustion chamber of an engine. The gas analysers can also be used to diagnose engine running faults and the measure the performance of emission control systems.

Current gas analysers are capable of measuring around four or five gases from exhaust emissions. Information about these four or five gases are widely used to determine the condition of spark ignition engines. These generic gas analysers are currently not used for compression ignition engines because of difficulties resulting from the high soot content of exhaust gases from such engines. Gas analysers that are tolerant to soot content like nondispersive infrared (NDIR) systems are relatively expensive and rarely usually.

U.S. Pat. No. 4,257,258 discloses an electrostatic separator which filters particulates from exhaust gas. The electrostatic separator is, however, expensive, complicated and bulky as it requires a high voltage source and a heat exchanger to cool the exhaust gas.

It is an aim of the present invention to provide a system and method for analysing exhaust gas which at least partially overcomes the above-mentioned problems with the prior art.

According to an aspect of the invention, there is provided a system for analysing exhaust gas, comprising: a sensor for sensing a properly of exhaust gas; a conduit for transferring exhaust gas from part of an exhaust system to the sensor; and an inorganic filter element configured to remove particulates from exhaust gas between an end of the conduit and the sensor.

According to an aspect of the invention, there is provided a system for analysing exhaust gas, comprising: a sensor for sensing a property of exhaust gas; a conduit for transferring exhaust gas from part of an exhaust system to the sensor; and an inorganic filter element configured to remove particulates from exhaust gas upstream of the sensor and downstream of the exhaust system.

According to another aspect of the invention, there is provided a system for analysing exhaust gas, comprising: a sensor for sensing a properly of the exhaust gas; a conduit for transferring exhaust gas from the end of a tailpipe to the sensor: and an inorganic filter element configured to remove particulates from exhaust gas upstream of the sensor.

A filter element made from an inorganic material provides a thermally and chemically stable filter for removing particulates from exhaust gas. An inorganic filter element does not suffer from problems such as burning at high temperatures. Thus the gas analyser readings are more accurate as artefacts due to burning are not introduced into the exhaust gas upstream from the sensor. Furthermore, due to the increased thermal stability, the exhaust gas does not need to be cooled prior to filtering. Thus the system is simpler, cheaper and more lightweight than filters which require cooling of the exhaust gas. Also, the manufacturing process for the system is more efficient.

According to another aspect of the invention, there is provided a system for analysing exhaust gas, comprising: a sensor for sensing a properly of exhaust gas; a conduit for transferring exhaust gas from part of an exhaust system to the sensor; and a porous filter element, wherein the filter element is inert to exhaust gas and is configured to remove particulates from exhaust gas between an end of the conduit and the sensor.

According to another aspect of the invention, there is provided a system for analysing exhaust gas, comprising: a sensor for sensing a properly of exhaust gas; a conduit for transferring exhaust gas from part of an exhaust system to the sensor; and a porous filter element, wherein the filter element is inert to exhaust gas and is configured to remove particulates from exhaust gas upstream of the sensor and downstream of the exhaust system.

According to another aspect of the invention, there is provided a system for analysing exhaust gas, comprising: a sensor for sensing a properly of the exhaust gas; a conduit for transferring exhaust gas from the end of a tailpipe to the sensor; and a porous filter element, wherein the filter element is inert to exhaust gas and is configured to remove particulates from exhaust gas upstream of the sensor.

A filter element that is inert and can withstand high temperatures and chemical erosion provides more accurate readings by the gas analyser as artefacts due to, for example, burning are not introduced into the exhaust gas.

The material of the filter element can be sintered. The porosity of a material can be easily controlled during the sintering process. This allows a filter element to be formed with a required porosity that is uniform throughout the filter. Sintering also allows small pores to be formed. The pore size can also be relatively easily controlled to be substantially uniform throughout the filter element. Thus the filter element is less likely to suffer from defects such as large pores that would allow particulates to pass through the filer element. Additionally, a sintered material is likely to be inert to exhaust gas because it has already been raised to a temperature far above the temperature of the exhaust gas.

The filter element can be inert to exhaust gas at temperatures greater than 300° C., preferably up to 750° C.

The exhaust gas can have a temperature of around 300° C. and can go up to 750° C. Thus a filter element that is inert at these temperatures can help the gas analyser provide more accurate readings as artefacts due to chemical reactions are not introduced into the exhaust gas.

The filter element may be configured to remove particles from exhaust gas upstream of the sensor and downstream of the exhaust system.

The filter element can be arranged to remove particulates with a size greater than about 1000 nm. That is, the filter is arranged to remove particles with a size down to (optionally but not including) 1000 nm. The filter only lets particles with a size of 1000 nm or smaller through.

Removing particulates of sizes greater than 1000 nm from exhaust gas can help prevent damage to the sensor and/or inaccurate sensor readings. Thus the sensor is more reliable and is able to function over a longer period of time. Furthermore, the filter element helps prevent build up of the particulates on any components (e.g. conduits, connectors, pumps, sensors etc. . . . ) downstream of the filter. A high flow rate is also possible by removing particulates larger than 1000 nm, as the pore size of the filter can be relatively large. Thus the gas sensor can provide quicker and more accurate readings.

The filter element can be arranged to remove particulates with a size greater than about 500 nm, more desirably 100 nm from exhaust gas. That is, the filter element is arranged to remove particles down to (optionally but not including) 500 nm (preferably 100 nm). The filter lets particles with a size of 500 nm (preferably 100 nm) or smaller through.

Removing particulates of sizes greater than 100 nm from exhaust gas is even more effective in preventing damage to the sensor and/or inaccurate sensor readings. A larger effective filter area may be required in order to achieve a practical gas flow rate through the filter.

The size of the particle can be the maximum length in any cross-section of the particle.

The filter element can be made from a material selected from a group consisting of ceramics, metals, glasses and minerals. These materials are inert and can withstand very high temperatures and chemical erosion. Thus, a filter element made from these materials will not burn or react with the hot exhaust gas. The gas analyser readings are therefore more accurate as artefacts due to burning are not introduced into the exhaust gas upstream from the sensor. The exhaust gas does not need to be cooled prior to filtering, thus the system is simpler, cheaper and more lightweight than filters which require cooling of the exhaust gas. These materials can also be readily formed into a variety of shapes, thus providing a simple and efficient manufacturing process.

The filter element can be made from a silicate, carbide, oxide or titanate. The filter element can be made from a non-metallic carbide, metal silicate, metallic titanate or non-metallic oxide. For example, the filter element can be made from silicon carbide (SiC), cordierite, aluminium titanate, silica or asbestos.

These materials are particularly suitable for making filters for this application because they are inert, even at high temperatures. Thus, a filter element made from these materials will not burn or react with hot exhaust gas. As described above, the gas analyser readings are therefore more accurate.

In addition, SiC, for example, has a very high thermal conductivity, approximately 10 W/mK for a porous ceramic material. Other types of ceramic materials with the same porosity have significantly lower thermal conductivities. The thermal conductivity of the filter material can be important for the regeneration of a filter because during a particulate burn-off process a large amount of heat is produced. This heal needs to be dissipated throughout the filter body. If the thermal conductivity is too low, local hot spots arise, which may lead to decomposition of the filter material, especially in materials where the melting point is relatively low. The high thermal conductivity of SiC helps prevent the occurrence of hot spots and thus provides filters that have increased stability.

Cordierite is a magnesium iron aluminium cyclosilicate. It is relatively low in cost and can easily be formed into a variety of shapes. Therefore, fillers made from cordierite can be easily manufactured.

Aluminium titanate has good resistance to thermal shock due to a very low thermal expansion coefficient. Therefore, filters made from aluminium titanate are very stable and durable.

Silica is very resistant to corrosion and suitable for use at high temperatures. It is relatively low in cost and can easily be formed into a variety of shapes. Therefore, filters made from silica are stable, cheap and can be easily manufactured.

Asbestos is a naturally occurring silicate mineral that is stable at very high temperatures, has a high tensile strength and is resistant to chemical erosion. Therefore, fillers made from asbestos are very stable and durable.

The filter element can be made from fibres or a mesh or a foam. Filters made from these forms of materials can be easily shaped. Such filters allow for high flow rates and produce low backpressure.

The filter element can have an auto-ignition temperature of greater than 500° C.

A high auto-ignition temperature ensures that the filter element does not burn due to the hot exhaust gases (which can have a temperatures up to 300° C.). Thus, as described above, the gas analyser readings are more accurate as artefacts are not introduced into the exhaust gas. Furthermore, the filter element can be regenerated by burning off the collected particulates. The particulates combust at around 600° C. Heating the filter element to temperatures greater than this combustion temperature burns off the collected particulates. Thus the filter element is re-usable as it can be easily regenerated.

The conduit and/or filter element can be at least partially insertable into or attachable to the end of a tailpipe.

A conduit and filter element that is insertable into and attachable to the end of a tail pipe can help provide exhaust gas analysis for more than one motor vehicle. The system is therefore more efficient as a large number of motor vehicles can be analysed by a single system (e.g. the system is a stand alone unit in a vehicle testing workshop). The conduit and filter is removably attachable to the end of a tail pipe and is also removably attachable from the sensor. Thus the conduit and the filter can be attached to a number of different sensors, allowing a broader range of analysis of the exhaust gas. Furthermore, the system is easy to maintain as the conduit and filter are not fixed within the motor vehicle.

The filter element can have a filtration area greater than around 0.05 m² and less than around 0.6 m².

This allows the filter element to be dimensioned so that it can be inserted into the conduit and/or a tailpipe of a motor vehicle. A large filtration area allows the filter element to filter a larger volume of exhaust gas before getting blocked as the filter element does not get blocked as quickly as a filter element with a smaller filtration area. This allows the filter element to maintain a high flow rate and be used over a longer period of time.

The filter element can have a filtration efficiency greater than around of around 80% A filter element with a high filtration efficiency is advantageous as it allows the exhaust gas to pass though the system at a high flow rate while removing a large proportion of the particulates.

The filter element can comprise a plurality of porous walls.

A filter element with a plurality of porous walls can help increase the surface area of the filter. The increase in surface area allows the filter element to filter a larger volume of exhaust gas.

The walls of the filter element can have pore sizes smaller than 50 μm, preferably smaller than 20 μm.

The thickness of the walls of the filter element can be around 0.2 to 1 mm, preferably 0.3 to 0.5 mm.

A filter element with these pore sizes and wall thicknesses allow for a high filtration efficiency while maintaining a high flow rate.

The walls of the filter element can have a porosity of around 30 to 60%.

This allows a high flow rate to be achieved, while maintaining structural stability. A large pressure drop (which can be caused by a filter with low porosity) across the filter element is undesirable as this could lead to high backpressure, resulting in a reduction in the flow rate of exhaust gas through the filter. A high flow rate can be desirable for measuring the exhaust gas emissions as a function of time. For example, the emissions may need analysed when there is a change in the engine condition, for example at start up or a change in revs.

The filter element can be a wall-flow filter. A wall-flow filter can provide a large filtration area over a small volume. This can allow the filter element to be easily insertable into the tailpipe. A wall-flow filter also allows a high flow rate of exhaust gas through it.

The plurality of porous walls can define a plurality of inlet cells and a plurality of outlet cells that extend from an inlet end face of the filter element to the outlet end face of the filter element. The inlet cells can be open at the inlet end face and closed at or near the outlet end face and the outlet cells can be open at the outlet end face and closed at or near the inlet end face. The inlet cells can be arranged to allow exhaust gas to enter the filter element at the inlet end face and substantially stop at least particulates from exiting the inlet cell at the outlet end face and wherein the outlet cells can be arranged to allow the exhaust gas to exit the filter element at the outlet end face and stop exhaust gas from exiting the filter element at the inlet end face. This is an efficient way of getting a high effective filtration area in a low volume filter element.

The inlet cells are closed at the outlet end face of the filter element. The exhaust gas is not able to leave the filter through the same channel it entered and is forced to How through the porous walls. This allows the filter element to efficiently filter the exhaust gas and collect the particulates. Furthermore, high flow rates are possible as the cell walls are thin.

The filter element can have a cell density of between 550 to 1300 cells per square centimetre (90 and 200 cell per square inch). Filter elements with a cell density greater than 1300 cells per square centimetre (200 cells per square inch) can easily become blocked with the collected particulates. Thus the volume of exhaust gas that can be filtered by the filter is low. Filter elements with a cell density less than 550 cells per square centimetre (90 cells per square inch) can lead to a reduction in the density of the number of inlet cells per unit area. The reduced number of cells will also lead to a reduction in the number of porous walls and therefore a reduction in the surface area of the filter. Thus the filtration efficiency is reduced. A cell density in the above range allows for a high filtration efficiency while maintaining the pressure drop.

The filter element can have a honeycomb structure.

A honeycomb structure provides a structurally strong filter element while also providing a large filtration area per unit volume.

The system can further comprise a filter housing to house the filter element. A housing for the filter element can help provide easy insertion and removal of the filter element to and from the system.

The system can comprise a heating device to heat the filter element. The healing device can be arranged to heat the filter element to above 250° C., preferably above 600° C. In certain circumstances, it can be preferable to heat the filter element. For example, the heating device can be use to regenerate the filter when the filter becomes clogged. In another example, HCs can sometimes be absorbed into certain materials. Thus it may, in certain circumstances, be preferable to heat the filter element to desorb the HCs. This can help improve the accuracy of the gas sensor.

The healing device can be comprised within the filter housing.

The system can further comprise a vacuum pump arranged to suck exhaust gas through the filter element.

A vacuum pump can be provided to help increase the flow rate of the exhaust gas through the filter. A large pressure drop across the filter element can cause high backpressure. This can lead to a reduction in the flow-rate of exhaust gas through the filter and to the sensor. A vacuum pump can help force the exhaust gas through the filter, leading to a reduction in the backpressure and an increase in the flow rate. Furthermore, as the filter element becomes blocked with use, the vacuum pump can be adjusted to provide a greater vacuum, thus maintaining the flow rate of the exhaust gas through the filter and to the gas sensor.

The sensor can be arranged to measure the concentration of one or more of the gases selected from a group consisting or hydrocarbons, carbon monoxide, nitrogen oxides, carbon dioxide and oxygen. Measurement of these gases, which can be comprised in the exhaust gas, can help diagnose problems with the motor vehicle.

According to another aspect of the invention, there is provided a method of analysing exhaust gas using the system described above, comprising the steps of: using the conduit to transfer exhaust gas at least part of the way from the end of a tailpipe to the sensor; forcing the exhaust gas through the filter element upstream of the sensor: and sensing a properly of the filtered exhaust gas using the sensor.

According to another aspect of the invention, there is provided a method of analysing exhaust gas comprising the steps of: transferring exhaust gas from the end of a tailpipe to a sensor; filtering the exhaust gas to remove particulates by forcing the exhaust gas through an inorganic filter element, wherein the filter element is positioned upstream of the sensor; and sensing a property of the filtered exhaust gas.

The above methods may further comprise the step of: inserting or attaching the conduit and/or filter element to the end of the tailpipe.

According to another aspect of the invention, there is provided a method of analysing exhaust gas comprising the steps of: transferring exhaust gas from part of an exhaust system to a sensor; filtering the exhaust gas to remove particulates by forcing the exhaust gas through an inorganic filter element, wherein the filter element is positioned upstream of the sensor and downstream of the exhaust system; and sensing a properly of the filtered exhaust gas.

According to another aspect of the invention, there is provided a filter element for filtering exhaust gas in a system for analysing exhaust gas exiting the end of a tailpipe upstream of a sensor of the system, the filter element being made of an inorganic material and being configured to remove particulates from exhaust gas.

According to another aspect of the invention, there is provided a filter element for filtering exhaust gas in a system for analysing exhaust gas upstream of a sensor of the system and downstream of an exhaust system, the filter element being made of an inorganic material and being configured to remove particulates from exhaust gas.

Embodiments of the invention will now be described, by way of example only, with reference to the accompanying schematic drawings in which corresponding reference symbols indicate corresponding parts, and in which:

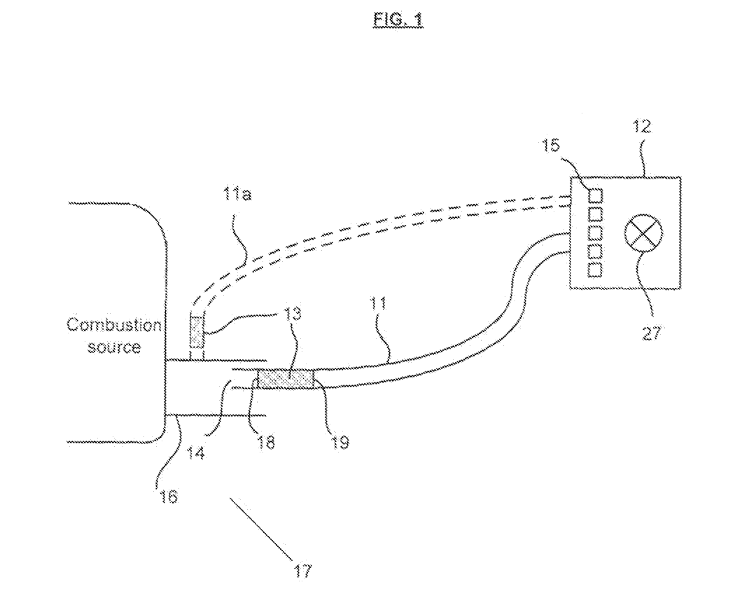

FIG. 1 depicts a system for analysing exhaust gas emitted from a combustion source, e.g. a motor vehicle;

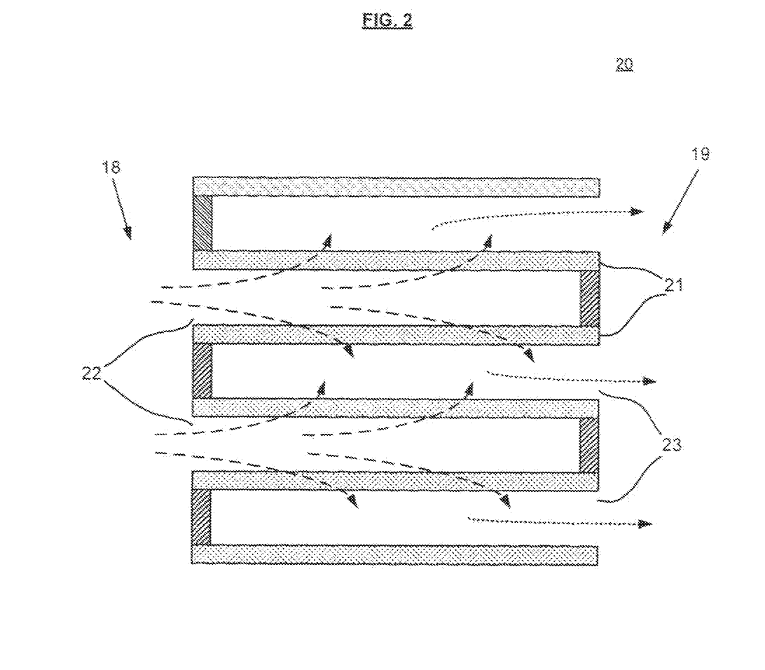

FIG. 2 depicts an example of a filter used in the system of FIG. 1; and

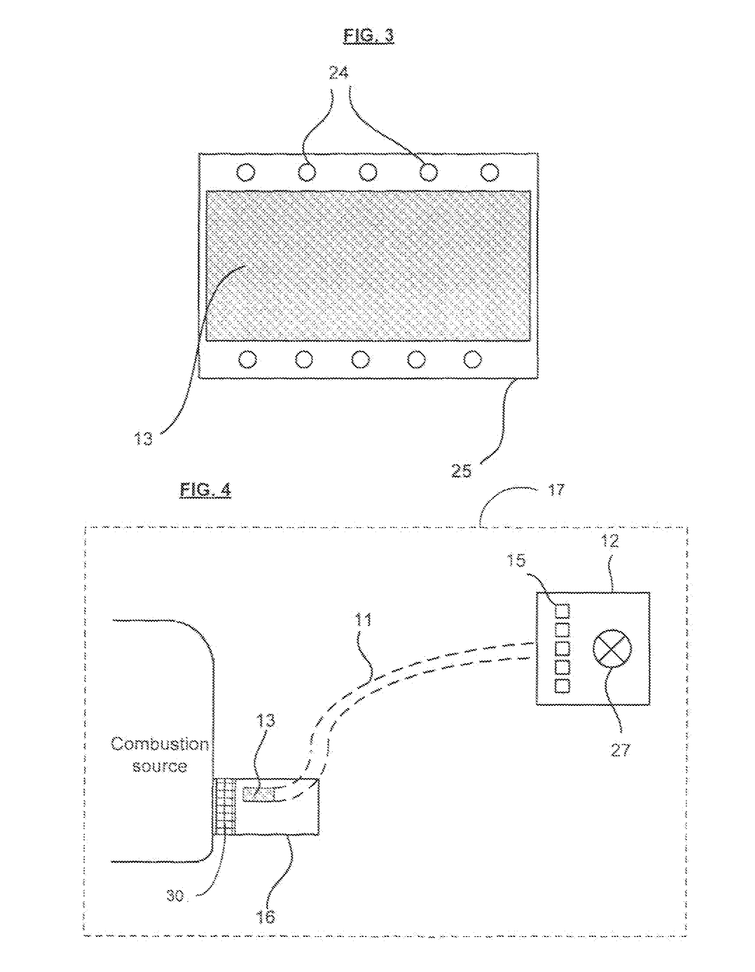

FIG. 3 depicts an example of a housing for a filter element; and

FIG. 4 depicts an on-board or in-line system for analysing exhaust gas emitted from a combustion source.

Gas analysers can suffer from inaccurate analysis of exhaust gases due to fine particulate matter, such as soot, carried by the exhaust gases. The soot can block line filters (e.g. filters made from paper, fibre and plastic meshes e.g. organic materials) and damage sensors measuring the gaseous emissions. Paper filters also have relatively low filtration rates only filtering soot greater than 2 to 5 micron in size and due to their low surface area readily become blocked. The problem of soot is particularly severe for emissions from compression ignition engines, where dedicated and expensive gas analysers are presently required.

To solve such a problem, the inventors attempted to place a filter between the gas analyser and the source of the exhaust gases. The inventors tried using paper filters to filter the soot from exhaust gas exiting a tailpipe upstream of sensors of a standard (spark ignition) gas analyser. However, the inventors found that paper filters suffer various problems such as thermal damage due to the hot exhaust gas. Burning of the paper filters created artifact emissions which led to incorrect readings by the gas analysers. Furthermore, the paper fillers absorbed 11Cs which leads to incorrect 11C readings.

FIG. 1 depicts a system 10 for analysing exhaust gas from combustion source, e.g. a motor vehicle. The system 10 comprises a conduit 11. The conduit 11 receives and/or transfers exhaust gas at least part way from a tailpipe 16 of a motor vehicle to a gas analyser 12. The end of the tailpipe 16 is the end of the exhaust system of a motor vehicle, where the exhaust gases expelled from the motor vehicle. The gas analyser 12 analyses a property of the exhaust gas using at least one sensor 15, as described below. A filter element 13 is provided upstream of the gas analyser 12 to filter the exhaust gas. The filtered exhaust gas is conveyed to the gas analyser via the conduit 11. The conduit 11 can be dimensioned so that it can be at least partially inserted into in the tailpipe. A part of or the entire conduit 11 can be inserted into the tailpipe. Exhaust gas can enter the conduit 11. Exhaust gas can enter an opening 14 in the conduit 11.

Alternatively, the conduit 11 can be dimensioned to fit around the tailpipe 16. This allows all of the exhaust gas to be collected by the conduit 11. The conduit 11 can form an air-tight seal around the tailpipe 16 so that only the exhaust gas is conveyed to the gas analyser 12. The conduit 11 can also be placed close to, but not into, the end of the tailpipe such that exhaust gas is receivable by the conduit.

Alternatively, the conduit transfers exhaust gas at least part way from any part of an exhaust system through which exhaust gases flow (for example, a cylinder head, a turbocharger, a catalytic converter, a pipe, a silencer, etc. . . . ). This is depicted in FIG. 1 by the dotted lines, where the conduit 11a is connected to the tailpipe 16, up stream from the end of the tailpipe 16 such that exhaust gas can enter the conduit 11a. The filtered exhaust gas can be transferred to a sensor that may be part of a management and/or monitoring system that is part of a device incorporating a combustion source, for example, may be part of a motor vehicle.

The exhaust gas received by the conduit 11 can be conveyed to the filter element 13. The filter element 13 can be placed anywhere upstream of the conduit 11, along the conduit 11 or in the gas analyser 12. If in the conduit 11, the filter element 13 may be placed anywhere from the opening 14 end of the conduit 11 to the end adjacent to the gas analyser 12. Alternatively, the filter element 13 can be attached to either end of the conduit 11, but not within the conduit, for example, the filter element 13 can be attached to the opening 14 of the conduit 11, such that the conduit 11 receives filtered exhaust gas from the filter element 13. The filter element 13 can be placed downstream or upstream of the opening 14 of the conduit 11. The conduit 11 may be flexible or solid. The conduit 11 may be at least partially or even fully formed by the filter element 13, housing 25 or even outer walls of the filter element 13.

The filter element 13 and the sensor 15 may be adjacent to each other. The filter element 13 and the adjacent sensor 15 may be at least partially insertable into the end of the tailpipe 16. The filter element 13 and the sensor 15 may be housed in a probe that is insertable into the end of the tailpipe 16. The probe can form part of the conduit 11.

The conduit 11 and the filter element 13 can be removably detachable from the tailpipe 16. The conduit 11 and the filter element 13 can also be removably detachable from the gas analyser 12. The conduit 11 and the filter element 13 can be separate and independent of the tailpipe and/or any part of the motor vehicle. The system 10 can be separate and independent of the tailpipe and/or any part of the motor vehicle. The system 10 can be removably attachable to the tailpipe and/or any part of the motor vehicle. The system 10 can be a stand alone unit for testing the emissions of a plurality of vehicles.

Alternatively, the conduit (or sample line) can be attached to any part of the exhaust system of a combustion source to transfer exhaust gas to a sensor (or gas analyser). The conduit (sample line) can be attached or placed upstream from the end of an exhaust system or can be placed downstream from the end of the exhaust system, but close enough such that exhaust can be received by the conduit (sample line). For example, the conduit (sample line) can be placed upstream or downstream of a diesel particulate filter. In other examples, the conduit (sample line) can be placed or attached upstream or downstream of a catalytic converter or on the catalytic converter. In another example, the conduit (sample line) can be placed or attached upstream or downstream of a silencer or on the silencer of an exhaust system.

The sensor may be part of a device that incorporates a combustion source, for example, a sensor for a monitoring and/or management system of a motor vehicle. The filter element filters exhaust gas upstream of the sensor. The filter element can filter exhaust gas downstream of the exhaust system. The filter element can form part of the conduit for transferring exhaust gas from any part of the exhaust system to the sensor. The filter element may be removably attachable from the motor vehicle.

Preferably, the filter element 13 has high filtration efficiency (e.g. >80% in terms of particle mass and/or particle number), high maximum operating temperature, low thermal expansion, resistance to thermal stress, high soot holding capacity, thermal shock resistance, strength and mechanical integrity and chemical resistance to metal oxides (ash) present in particulates. The filter element should also be chemically stable, being resistant to exhaust gas components (including sulphur), have a low reactivity with ash compounds and oxidation resistance. The filter element 13 can be made from a number of materials, as discusses below, to meet these criteria.

Furthermore, the filter element 13 should have a low pressure drop across it when empty or loaded with particulates and ashes. Also the filter element 13 should have a low scatter of pressure drop (i.e., repeatable pressure drop values at a given gas flow rate and soot load).

The filter element 13 can be made from an inorganic material, such as carbides, silicates, oxides, titantates, SiC, cordierite, ceramics, metals, alloys or minerals or the like. The term inorganic is used to exclude, for example, petrochemical or pertochemically derived materials and materials derived from living organisms. In one embodiment, the filter element 13 can be made from any suitable material that is inert to exhaust gas.

A filter element made from an inorganic material can provide a thermally and chemically stable filter element for removing particulates from exhaust gas. An inorganic filter element does not suffer from problems such as burning at high temperatures. Thus the gas analyser 12 readings are more accurate as artefacts due to burning are not introduced into the exhaust gas upstream from the sensor 15. Furthermore, due to the increased thermal stability, the exhaust gas does not need to be cooled prior to filtering. Thus the system 10 is simpler, cheaper and more lightweight than fillers which require cooling of the exhaust gas. Also, the manufacturing process for the system 10 is more efficient.

The filter element 13 can be made from a silicate or carbide. The filter element 13 can be made from a non-metallic carbide (such as SiC) or a metal silicate (such as cordierite). These classes of materials are well suited to this application, as described below.

Ceramics, such as SiC and cordierite (which is a magnesium iron aluminium cyclosilicate), and metals, such as stainless steel and Fe Cr alloy, such as Fecralloy (RTM) available from Goodfellow Cambridge Ltd, Huntingdon. UK, can be made to be porous to the exhaust gas. Sintering, or any other suitable manufacturing method, can be used to form porous ceramics, metals or any other suitable material (for example, plastics). The filter element 13 can be made from sintered materials. The porosity of a material can be easily controlled during the sintering process. Thus a filter element 13 can be formed with a required porosity that is uniform throughout the filter element 13. Sintering allows relatively small pores to be formed. The pore size can also be easily controlled during the sintering process. The filter element 13 is therefore less likely to have large defective pores that allow particulates to pass through the filer 13. Complicated shapes can also be easily formed using the sintering process. Additionally, a sintered material is likely to be inert to exhaust gas because it has already been raised to a temperature far above the temperature of the exhaust gas. The filter element 13 can be made from ceramic and/or metal fibres or meshes.

The exhaust gases emitted from the tailpipe 16 of a motor vehicle 17 can be corrosive and hot. The exhaust gases can have temperatures of around 300° C. The exhaust gases can reach temperatures of up to 750° C. Thus, preferably, the filter element 13 is made from a material that is inert to exhaust gases at temperatures above about 250° C. (around 300° C.) and preferably up to 750° C. The material does not need to be inert to exhaust gases at a temperature of over 1000° C. for example.

Burning caused by the heat from the exhaust gas can cause gases and/or particulates to be introduced into to the exhaust gas stream. The inventors have tried filters made from paper, which has an auto-ignition temperature of around 450° C. However, it was found by the inventors that the paper burned in the hot exhaust gas. It is therefore desirable that the filter element 13 is made from a material that has an auto-ignition temperature above the temperature of the exhaust gas and preferably above 500° C.

The above physical requirements can be met by, for example, silicon carbide, for example, silicon carbide coated alumina fibres, cordierite, aluminium titanate, sintered metals, metal meshes and knitted wires, ceramic fibres, ceramic marts and meshes, silica fibres, asbestos and ceramic foams.

A clogged filter can be regenerated by healing the filter element 13 to above 600° C. Above this temperature, the particulates (which are mainly made up of carbon) start to oxidise into gases (such as CO₂). The filter element 13 can reach temperatures above 750° C. during regeneration. Therefore it is desirable that the filter element 13 is made from a material, such as SiC or cordierite, that is thermally and chemically stable at these temperatures. The filter element 13 can be reused after regeneration. A filter made from SiC or cordierite, for example, can be regenerated around 10 times.

Filters made from materials with a relatively high thermal conductivity, such as SiC, can also be desirable. During combustion of the particulates, a large amount of heat is produced. This heat needs to be dissipated throughout the filter body. If the thermal conductivity is too low, local hot spots arise, which may lead to decomposition of the filter material, especially in materials where the melting point is relatively low. The high thermal conductivity of SiC helps prevent the occurrence of hot spots and thus provides filters that have increased stability.

Impacts during use damage the filter element 13. Thus it is preferable that the filter element 13 has high structural strength. Due to repeated heating and cooling of the filter (when in use and when it is regenerated), it is also preferable that the filter has high thermal and mechanical durability.

In certain circumstances, it may be desirable that the tiller element 13 is made from a material that is porous to exhaust gas. A filter element 13 made from a material that is porous to exhaust gas can provide a structurally and thermally stable material for removing particulates from exhaust gas. A porous material can maintain its shape when heal and/or pressure is applied to it. Furthermore, the pore size can remain constant under heat and/or pressure.

In certain circumstances, metallic fibre or mesh filters made from materials that are not porous to exhaust gas can easily deform when heat and/or pressure is applied to it. This deformation can lead to a change in size of the gaps between the fibres. This change can lead to an undesired change in the size of particulates filtered and a change in the flow rate through the metallic fibre or mesh filter.

Furthermore, in certain circumstances, a filter made of a porous material may have a better thermal conductivity than metallic a fibre or mesh filter made from a non-porous material. Fibres at a front face of a filter, that is exposed to hot exhaust gas, may become very hot as the fibres may have limited conduction paths, thus restricting the ability to dissipate heat through the filter. In certain circumstances, due to the lack of heal dissipation, the fibres may become hot enough to burn. As described above, burning could introduce artefacts into the exhaust gas which could lead to inaccurate readings by the sensor 15. A filter made from a porous material can have better thermal properties because more of the solid components of the material are in contact with each other, thus allowing the heat to conduct away. Furthermore, in certain circumstances, wire meshes may not be able to filter small panicles less than 2 microns in size. Also, in certain circumstances, wire meshes may act as a catalyst to the exhaust gases so that the exhaust gases react and change character before reaching the sensor, thus providing inaccurate readings.

The filter element 13 can be a single structure, or element. The filter element does not require another component or part to function as a filter.

The exhaust gas emissions from a motor vehicle can comprise particulates ranging in size from 20 nm to over 10 μm. Particulates greater than 100 nm in size can damage sensors and can cause false readings. The filter element 13 can remove (e.g. all) particulates greater than about 100 nm preferably 500 nm and more preferably 100 nm in size from the exhaust gas. Therefore, the filter element filters particles down to (and optionally not including) 1000 nm (preferably 500 nm. more preferably 100 nm) from the exhaust gas. By filtering down to these sizes it is possible to achieve good flow rates with a smaller filtration area. Removing particles above the above mentioned sizes from the exhaust gas prevents damage to the sensors.

Filtering small particles requires a filter element 13 with small pore sizes. This can lead to a low flow rate of exhaust gas through the filter element 13. Furthermore, a filter element 13 with a small pore size can quickly become clogged. Thus it may be preferable to provide a filter element 13 that has large pore sizes and thus filters larger particulates, for example particulates greater than about 100 nm in size. This can lead to in increase in the flow rate. It is therefore preferable that the filter is made from a material with pore sizes between 5 μm and 60 μm, preferably 10 μm to 40 μmm, and preferably between 10 μm and 20 μm.

More than one filter element 13 may be utilised. For example, the system may comprise two filters (in series and/or in parallel depending on the arrangement). Each filter may be arranged to filter a different range of particle sizes. For example, a filter that filters large particles can be placed upstream from a filter that filters smaller particles. Filters with small pore sizes can quickly become blocked with large particles. Thus providing a filter with large pore sizes to filter the large particles from the exhaust gas upstream from a filter with small pore sizes can help provide a system which can filter a lager range of particle sizes for a larger volume of exhaust gas compared to a single filter with small pore sizes. A good flow rate can also be maintained over a larger volume of filtered exhaust gas as there may be a smaller total pressure drop over the two filters compared to a single clogged filter with small pores.

The exhaust gas can enter the filter element 13 at an inlet end face 18. The inlet end face 18 is the face of the filter element 13 that is exposed to the flow of the exhaust gas. The exhaust gas passes through the filter element 13 and exits the filter element 13 at an outlet end face 19. The filtered exhaust gas is then conveyed (via, for example, the conduit 11) to the gas analyser 12.

The gas analyser 12 comprises at least one sensor 15 to measure at least one property of the filtered exhaust gas. Preferably, the sensors 15 of the gas analyser 12 measure the quantity of gases, such as CO, HC, NOₓ, CO₂, O₂, SOₓ, in the exhaust gas. The sensors 15 can be arranged to measure the absolute quantity and/or the relative quantity of the gases in the exhaust gas. The gas analyser 12 can measure one or more of the gases, and preferably four or more of the gases.

The concentration of the gases measured can be used, for example, to determine a condition of the motor vehicle 17 or determine if the emissions meet certain standards. The gas measurements by the gas analyser 12 can provide information that can be used to diagnose a number of problems of the motor vehicle 17. Such problems can include drive ability issues, ignition system problems, fuel management issues, engine mechanical problems, excessive emissions problems and many others. The gas analyser 12 may be separate and independent of the motor vehicle 17 and not part of any internal systems of the motor vehicle 17. Alternatively, the gas analyser 12 may be carried on board as part of a monitoring system for on board diagnostics.

Gas analysers, such as the four/five gas analysers that are commonly used to measure the emissions from spark ignition engines can be used as part of the system 10. These four/five gas analysers are normally unsuitable for measuring emissions from compression ignition engines clue to the amount of soot produced. However, the filter element 13 can remove the soot to allow the four/five gas analysers to be measure emissions from compression ignition engines.

The gas analyser 12 can comprise a vacuum pump 27 which provides suction for forcing the exhaust gas through the filter element 13 and towards the gas analyser 12. Alternatively or additionally, a vacuum pump 27 can be provided that is separate from the gas analyser 12. The vacuum pump 27 can be configured to provide a constant flow-rate of exhaust gas to the gas analyser 12. The filter element 13 can become blocked as the collected particulates build-up within the filter element 13. This leads to a decrease in the flow-rate of exhaust gas through the filter element 13. The vacuum pump 27 can be configured to adjust the partial vacuum to compensate for the increased blockage in the filter element 13 to maintain a constant flow-rate.

Preferably, the filter element 13 has a relatively low pressure drop across it and a relatively high filtration efficiency. A low pressure drop is desirable to maximise the How rate of the exhaust gas through the filter. A low pressure drop also reduces the backpressure, thus more exhaust gas is able to be drawn into the filter. Furthermore, the low pressure drop requires the vacuum pump to do less work to suck exhaust gas through the filter.

To obtain a high flow rate, it is preferable that the filter has a porosity of between about 30 and 50%. This provides a reduction in the backpressure and allows the exhaust gas to arrive at the sensor with minimal delay. This is especially advantageous when the exhaust gas is being measured as a function of time.

The filter element 13 can be formed from a porous ceramic or metallic block. The effective filtration area can be defined as the total area of the filter medium that is exposed to flow and is usable for the filtration process. The effective filtration area for a block with a flat face at the inlet end face 18 is the area of the face. It may be desirable to increase the effective filtration area to increase the filtration efficiency.

The effective filtration area of the filter element 13 can be increased by increasing the size of inlet end face 18. However, this may not be practical, especially if the filter element 13 is part of a probe 15 that is inserted into the tailpipe 16.

The filter element 13 may be shaped into a cuboid, a polyhedron, a cylinder or the like. The filter element 13 may have a cross-sectional area of between 0.1 and 0.6 cm² and a length of between 1 cm and 4 cm. For example, a cylindrical filter element 13 can have, a diameter of between 1 and 3 cm and desirably around 1.5 cm, and a length of between 1 cm and 3 cm and preferably around 2.5 cm.

The effective filtration area of the filter element 13 can be between 0.1 m² and 0.6 m². The filter element can have a filtration area of around 0.4 to 0.6 m² per litre of volume. A wall-flow filter can provide a large effective filtration area, while having a small volume. The wall-flow filter can be shaped to be a polyhedron, a cylinder or the like. The filter element 13 can be a wall-flow filter.

FIG. 2 depicts part of a cross-section of a wall-flow filter 20. The wall-flow filter 20 comprises a plurality of interconnected porous walls 21. The walls 21 define a plurality of exhaust gas inlet channels 22 (also referred to as “inlet cells”) and a plurality of exhaust gas outlet channels 23 (also referred to as “outlet cells”). The inlet and outlet cells 22 and 23 extend longitudinally from the inlet end face 18 to the outlet end face 19 of the filter 20. The walls 21 of the inlet cells 22 provide a large surface area, which is exposed to the flow of the exhaust gas, thus providing a large effective filtration area. The cells 22 and 23 can have a cross-section of any shape, particularly those that can be close packed but including, for example, squares, hexagons, octagons, rectangles, circles, triangles and combinations thereof. The wall-flow filter 20 can have a honeycomb structure.

The inlet cells 22 are open at the inlet face end 18 and closed at the outlet face end 19. The outlet cells 23 are adjacent to the inlet cells 22. The outlet cells 23 are open at the outlet face end 19 and closed at the inlet face end 18. The inlet and outlet cells 22 and 23 can be closed at one end by using a suitable plugging material or by any other means that does not allow the exhaust gas to pass through it.

The exhaust gas enters the inlet cells 22 at the inlet end face 18. The inlet cell is closed at the opposite end to prevent the exhaust gas from passing straight through the wall-flow filter 20. Thus the exhaust gas is forced through the porous walls 21, which retains the particulates from the exhaust gas. The particulates can become trapped on the surface of the walls 21 of the inlet cell or in the pores of the wall. The filtered exhaust gas enters an adjacent outlet cell and exits the wall-flow filter 20 from the outlet end face 19. The flow arrows in FIG. 2 illustrate the flow path that exhaust gas takes through the inlet and outlet cells 22 and 23.

The porosity of wall material is preferably between about 30% to 50%, by volume. To achieve low backpressure, the porosity of the walls 21 may be made to be greater than 60%. To maintain structural strength of the wall-flow filter 20, the total porosity of the walls 21 should desirably be less than about 40%.

The wall thickness may be between 0.2 and 1 mm. In certain circumstances, to ensure adequate structural strength and filtration efficiency of the wall-flow filter 20, the wall thickness may be greater than about 0.4 mm (with a porosity value of about 40%). To ensure relatively low backpressure, the wall thickness may be less than 0.8 mm. To ensure high filtration efficiency with relatively low backpressure the wall thickness (W) and pore size (PS) may be selected such that the W/PS ratio is greater than 0.4. Preferably, the wall thickness is between about 0.3 and 0.5 mm.

A wall-flow filter 20 with a cell size that is too small can become easily clogged. Conversely, a wall-flow filter 20 with a cell size that is too big can have a low filtration efficiency. A cell with a cross-sectional area of between 0.1 and 0.6 cm² can provide a good balance between the filtration efficiency and the rate of blockage.

Furthermore, a good balance can also be achieved with a cell density of between around 588 to 1290 cells per square centimeter (90 to 200 cells per square inch.

As shown in FIG. 3, any of the above described filter elements 13 can be provided with a housing 24 that allows the filter element 13 to be easily removed and re-inserted into the system 10. The housing 24 can, for example, be connectable to the conduit 11. The housing 25 may also comprise a heater 25 to heat the filter element 13. A metallic filter could be heated by providing a current. In some circumstances, HCs from the exhaust gas can absorb onto certain materials. By heating the filter element 13 to around 300° C. the HCs it may be possible to stop absorption of the HCs on to the filter 12. The heater 24 can also heat the filter element 13 to around 600° C. to regenerate the filter element 13 (e.g. to remove the solid soot particulates).

FIG. 4 illustrates a further embodiment which is the same as the foregoing embodiments except as described below. Features from any embodiment may be present in any other embodiment. For example, in the embodiment of FIG. 4, a diesel particulate filter 30 is illustrated in the tail pipe 16. The diesel particulate filter 30 is upstream of the filter element 13. Such a diesel particulate filter 30 may be present in any other embodiment.

In the embodiment of FIG. 4, the gas analyzer 12 is mounted on the vehicle 17 and is normally part of the vehicle 17. That is, the gas analyzer 12 is on board the vehicle 17 during normal use. This allows in-line analyzing of exhaust gas emissions. To this end, the filter element 13 is permanently mounted in the tail pipe 16 (it may be removable so that it can be replaced and/or cleaned). The conduit for transferring exhaust gas from part of the exhaust system to the sensor is partly made up of the housing of the filter element 13 so that the filter element 13 is configured to remove particles from exhaust gas between an end of the conduit and the sensor 15. Alternatively the filter element 13 may be in a branch line off the tail pipe 16, such as is illustrated in FIG. 1.

The filter element 13 is downstream of the diesel particulate filter 30. However, this is not necessarily the case and the filter element 13 could be positioned upstream of the diesel particulate filter 30.

The sensor 15 is not for measuring the filtering performance of the filter element 13 or for measuring the character or presence of soot. The sensor 15 is for analyzing gaseous components of the exhaust gas. The sensor 15 is for sensing a properly (e.g. concentration of gases) of the exhaust gas. The sensor 15 is not for measuring the pressure of the exhaust gas. The sensor 15 is for measuring the composition of exhaust gas, for example the composition of a sample taken from the exhaust gas.

The sensor 15 is of the type deleteriously effected by panicles in the gas being sampled.

The present invention can be utilised in areas other than motor vehicles. The invention can be applied to emissions from, for example, furnaces, boilers, heat generators, electricity generators, power plants or any other emissions resulting from the combustion of fuel.

1. A system for analysing exhaust gas, comprising:
a sensor for sensing a property of exhaust gas;
a conduit for transferring exhaust gas from part of an exhaust system to the sensor; and
an inorganic filter element configured to remove particulates from exhaust gas between an end of the conduit and the sensor.

2. A system for analysing exhaust gas, comprising:
a sensor for sensing a property of exhaust gas;
a conduit for transferring exhaust gas from part of an exhaust system to the sensor; and
a porous filter element, wherein the filter element is inert to exhaust gas and is configured to remove particulates from exhaust gas between an end of the conduit and the sensor.

3. A system according to any one of the preceding claims, wherein the material of the filter element is sintered.

4. A system according to any one of the preceding claims, wherein the filter element is inert to exhaust gas at temperatures greater than 300° C., preferably up to 750° C.

5. A system according to any one of the preceding claims, wherein the filter element is arranged to remove particulates with a size down to but not including about 1000 nm from exhaust gas.

6. A system according to claim 5, wherein the filter element is arranged to remove particulates with a size down to but not including about 500 nm, desirably 100 nm from exhaust gas.

7. A system according to any one of the preceding claims, wherein the filter element is made from a material selected from a group consisting of ceramics, metals, glasses and minerals.

8. A system according to any one of the preceding claims, wherein the filter element is made from a material selected from a group consisting of silicates carbides, oxides and titanates.

9. A system according to claim 8, wherein the filter element is made from a material selected from a group consisting of metal silicates, non-metallic carbides, metallic titanates and non-metallic oxides.

10. A system according to any one of the preceding claims, wherein the filter is made from a material selected from a group consisting of silicon carbide, cordierite, aluminium titanate, silica and asbestos.

11. A system according to any one of the preceding claims, wherein the filter element is made from a material porous to exhaust gas.

12. A system according to any one of the preceding claims, wherein the filter element is made from fibres or a mesh or a foam.

13. A system according to any one of the preceding claims, wherein the filter element has an auto-ignition temperature of greater than 500° C.

14. A system according to any one of the preceding claims, wherein the conduit and/or filter element are at least partially insertable into or attachable to the end of a tailpipe.

15. A system according to any one of the above claims, wherein the filter element has a filtration area greater than around 0.05 m².

16. A system according to any one of the above claims, wherein the filter element has an effective filtration area less than around 0.6 m².

17. A system according to any one of the preceding claims wherein filter element has filtration efficiency greater than around 80%.

18. A system according to any one of the preceding claims, wherein the filter element comprises a plurality of porous walls.

19. A system according to claim 18, wherein the walls have a pore sizes smaller than 50 μm, preferably smaller than 20 μm.

20. A system according to claim 18 or 19, wherein the walls have a porosity of around 30 to 60%.

21. A system according to any one of claims 18 to 20, wherein the thickness of the walls is around 0.2 to 1 mm, preferably 0.3 to 0.5 mm.

22. A system according to any one of the preceding claims, wherein the filter element is a wall-flow filter.

23. A system according to any one of claims 18 to 22, wherein the plurality of porous walls define a plurality of inlet cells and a plurality of outlet cells that extend from an inlet end face of the filter element to the outlet end face of the filter element.

24. A system according to claim 23, wherein the inlet cells are open at the inlet end face and closed at or near the outlet end face and the outlet cells are open at the outlet end face and closed at or near the inlet end face.

25. A system according to claim 24, wherein the inlet cells are arranged to allow exhaust gas to enter the filter element at the inlet end face and substantially stop at least particulates from exiting the inlet cell at the outlet end face and wherein the outlet cells are arranged to allow the exhaust gas to exit the filter element at the outlet end face and stop exhaust gas from exiting the filter element at the inlet end face.

26. A system according to any one of claims 23 to 25, wherein the filter element has a cell density of around 550 to 1300 cells per square centimetre (90 to 200 cells per square inch).

27. A system according to any one of the preceding claims, wherein the filter element has a honeycomb structure.

28. A system according to any one of the preceding claims, wherein the conduit transfers exhaust gas from the end of an exhaust system.

29. A system according to claim 28, wherein the end of an exhaust system is the end of a tailpipe.

30. A system according to any one of the preceding claims, wherein the exhaust system is part of a motor vehicle.

31. A system according to any one of the preceding claims, further comprising a filter housing to house the filter element.

32. A system according to any one of the preceding claims, further comprising a heating device to heat the filter element.

33. A system according to claim 30, wherein the heating device is comprised within the filter housing.

34. A system according to claim 30 or 31, wherein the heating device is arranged to heat the filter element to above 250° C., preferably above 600° C.

35. A system according to any one of the preceding claims, further comprising a vacuum pump arranged to suck exhaust gas through the filter element.

36. A system according to any one of the preceding claims, wherein the sensor is arranged to measure the concentration of one or more of the gases selected from a group consisting of hydrocarbons, carbon monoxide, nitrogen oxides, carbon dioxide and oxygen.

37. A method of analysing exhaust gas using a system according to any one of the preceding claims, comprising the steps of:
using the conduit to transfer exhaust gas part of an exhaust system to the sensor;
forcing the exhaust gas through the filter element which is positioned between an end of the conduit and the sensor; and
sensing a property of the filtered exhaust gas using the sensor.

38. A method of analysing exhaust gas comprising the steps of:
transferring exhaust gas from part of an exhaust system to a sensor via a conduit;
filtering the exhaust gas to remove particulates by forcing the exhaust gas through an inorganic filter element, wherein the filter element is positioned between an end of the conduit and the sensor; and
sensing a property of the filtered exhaust gas.

39. A method according to claim 38, wherein the filter element is made from a material porous to exhaust gas.

40. A method according to any one of claims 37 to 39, further comprising the step of:
inserting or attaching the conduit and/or filter element to the end of a tailpipe.

41. A filter element for filtering exhaust gas in a system for analysing exhaust gas, the filter element being made of an inorganic material and being configured to remove particulates from exhaust gas, wherein the filter element is between an end of a conduit for transferring exhaust gas from part of an exhaust system and a sensor for sensing a property of exhaust gas.

42. A system constructed and arranged to operate substantially as hereinbefore described with reference to the accompanying drawings.

43. A method substantially as hereinbefore described with reference to the accompanying drawings.
